(19) United States
(12) Patent Application Publication
(10) Pub. No.: US 2017/0028773 A1
(43) Pub. Date: Feb. 2, 2017

(54) Process for Creating Three-Dimensional Aluminum Artwork

(71) Applicant: David May, St. Petersburg, FL (US)

(72) Inventor: David May, St. Petersburg, FL (US)

(21) Appl. No.: 14/810,875

(22) Filed: Jul. 28, 2015

(51) Int. Cl. B44C 3/02; B44C 3/00

(52) U.S. Cl. CPC B44C 3/025; B44C 3/005

(57) ABSTRACT

A method of creating three-dimensional art using a unique combination of aluminum, metallic foils, colored glazes, metallic paint, and mica powder pigments thereby obtaining opalescent, luminescent, and iridescent effects in lighting and coloring as well as more pleasing three-dimensional effects than have been produced to date.

### FIELD

This invention relates to the field of three-dimensional artwork and more particularly to a process of creating three-dimensional artwork that captures iridescent, opalescent, and luminescent effects that occur in nature.

### BACKGROUND

Artists are always trying to create lifelike art. This can be done using various artistic techniques. For example, texture, lighting, and shading can all be used to create a lifelike feel in a piece of art.

Skilled artists use shadows and lighting effects that impart a realistic appearance to a piece of art. But none of the prior art techniques capture the iridescent, opalescent look of a fish or cetacean in water. What is needed is a method that captures the luminescent, iridescent, and opalescent look of organisms that display those lighting effects in their natural environments.

### SUMMARY

This invention relates to a process for creating three-dimensional artwork using a unique combination of aluminum, colored glazes, metal foils, metallic paints, and powder pigments. The result is an artwork with ultra-realistic and more pleasing effects in lighting as well as superior three-dimensional effects.

The process disclosed within can be used to create works of art depicting various objects that have a naturally iridescent, opalescent, or luminescent appearance. Examples of organisms that are suitable for the process are fish, whales, insects, flowers, butterflies, aquatic mammals, cetaceans, cartilaginous fish, and bioluminescent organisms.

Using the process, one layers the materials together creating unique physical characteristics. These physical characteristics provide shape, texture, color, and lighting effects.

The first step is to cut paper card stock into a desired shape. The second step in the process is to cut aluminum to match the shape of the card stock. The third step is to attach the aluminum to the card stock. The fourth step is to decide which three-dimensional characteristics will be included in the particular piece of art. The three-dimensional characteristics—steps five, six, seven, and eight, respectively—include: embossing, scoring, and cutting and elevating.

After the three-dimensional steps, the ninth step is to apply metallic foil on the artwork. The metallic foil creates an iridescent, opalescent effect that further enhances the three-dimensional appearance. The tenth step is to apply metallic paint. Similarly to the metallic foil, the metallic paint enhances the three-dimensional effects through improved reflective and refractive properties. The eleventh step is to apply glazing. The glazing creates a shimmery, luminescent effect. The final step is to apply mica powder.

Now turning to a more in depth discussion of each of the steps.

Cut Paper Card Stock into Desired Shape and Cut Aluminum

The first two steps are more easily understood when discussed in conjunction with one another. In some embodiments, the bottom layer is card stock. In other embodiments, the bottom layer is aluminum. The object of the first two steps is to create a base upon which the three-dimensional effects will be created through a series of layers.

The first step is to cut paper card stock into the desired shape. The shape of the base may be an outline of a fish, a whale, a flower, an insect, or any other organism with a naturally iridescent, opalescent, or luminescent appearance.

The second step is to cut aluminum to match the shape of the card stock. The aluminum is more important to the process than the card stock. The combination of malleability, rigidity, and reflectivity make aluminum more suitable to create both the structural and lighting effects that yield the greatest three-dimensional characteristics in the final product.

The card stock provides a sturdy background for the layering of additional materials. But the card stock lacks the proper amount of rigidity and reflectivity of aluminum. Thus, the card stock is optional depending on if the aluminum to be used will be thick enough to maintain its shape without the need for card stock. If the artist uses a thinner aluminum, the aluminum will need to be adhered to a card-stock base. But if the artist uses a thicker aluminum, the aluminum alone is suitable as the base.

Now turning to the third step in the process.

Attach Aluminum to Paper Card Stock

In embodiments where the aluminum to be used is too thin to maintain its shape, a card stock base should be used. In these instances, once one has cut the card stock into a desired shape and has cut the aluminum, the aluminum must be attached to the card stock.

Attaching these two pieces forms the base upon which three-dimensional characteristics can be added to create the final artwork.

Now turning to the fourth step in the process.

Are Three-Dimensional Effects Desired?

If three-dimensional effects are desired, one can incorporate the three-dimensional effects by manipulating the card stock and the aluminum with various tools. The three-dimensional effects are created by any or all of the following: (1) embossing the surface to make a texture, (2) scoring lines to create wrinkles or grooves, (3) cutting and elevating, and (4) attaching additional pieces of aluminum to the base to create appendages.

Each three-dimensional characteristic can be applied to an artwork individually or all three-dimensional effects can be included on a single artwork.

Now turning to an explanation of embossing.

Emboss

The fifth step in the process is to emboss the artwork. Embossing is the raising or impressing of paper or other products using different tools. Examples of three-dimensional details that are created through embossing include: skin textures, scales, fin textures, throat pleats, and feathers.

To create skin or scale features, certain embossing materials are inserted between the aluminum, and the metallic foil. The lower gauge of foil conforms to the texture and allows the three-dimensional effects of the inserted embossing material to show through.

The embossing material can be textured plastic wrap, fine wire mesh, a nylon bag, or other suitable material depending on the desired texture. For example, the skin of a wahoo, mahi, rooster fish, or salmon is created by placing a textured plastic wrap between the aluminum and the metallic foil. Then, the metallic foil is pressed to reveal the texture of the plastic wrap. The result is that the texture of the material will show through the metallic foil as if the metallic foil has that texture naturally.

In embodiments depicting fish with more pronounced scales, the artist places a wire mesh over the metallic foil layer and applies the metallic paint. After the metallic paint is almost dry, the artist removes the wire mesh leaving grooves in the layer of metallic paint that resemble scales. Once the metallic paint fully dries, the paint will retain the raised look creating the effect of scales on a fish.

Now turning to an explanation of scoring.

Score

The sixth step in the process is to score the aluminum. Scoring is making notches, cuts, marks, or lines in or on something. Scoring can be used to add wrinkles or grooves to an artwork.

For example, in embodiments depicting cetaceans and baleen whales, the throat pleats provide an important three-dimensional effect. Instead of teeth, baleen whales have baleen plates in their mouths that act as a filter or sieve to strain food from water.

In order to ingest enough food, the throats and stomachs of baleen whales expand greatly to engulf a large amount of water and plankton. The whale then pushes out the water and strains it through the baleens. The baleens hold in any plankton, krill, and other particles present in the water. When not feeding, the extra skin folds into the throat and stomach of the whale.

Using the disclosed method, the throat pleats are created by scoring lines into the aluminum. As a result of the scoring, grooves are left in the aluminum that simulate wrinkles or folds.

Now turning to an explanation of the cutting and elevating step.

Cut and Elevate

The seventh step in the process is to cut and elevate portions of the aluminum to create three-dimensional structural features. Using a sharp cutting utensil, the aluminum can be cut and elevated, or raised away from the base. Such effects are used to simulate the operculum (gill plate cover) of a fish.

Fish breathe by taking in water through their mouths and passing it through the gills and out of the operculum. The operculum protrudes away from the body of the fish and closes back into the side of the fish during breathing.

To simulate the act of breathing, the artist first scores a semicircular cut where the operculum is located. Next, the operculum is pushed upward from the base creating the appearance of an operculum. Because the base is formed of card stock and aluminum, the cut and elevated three-dimensional effect will hold its position.

Now turning to an explanation of adding appendages.

Add Appendages

The eighth step in the process is to add appendages. This step is optional depending on the organism that the final product will portray. For example, the dorsal spine of a fish, wings on a dragonfly, or petals on a flower can be created using separate pieces of aluminum. The separate pieces of aluminum are then attached to the aluminum and card stock.

By way of example, one can add appendages to create a fins in embodiments depicting fish. The fins are made of metallic foil or aluminum. After the fins are cut into the desired shape, thin pieces of wire are attached to the fins to simulate spines.

Optionally, before the thin pieces of wire are attached, the fins can be scored to create grooves into which the thin pieces of wire will fit.

Now turning to a discussion of applying metallic foil.

Apply Metallic Foil

The ninth step in the process is to apply metallic foil. For additional brilliance, after applying the three-dimensional characteristics, the artist can choose from a wide variety of metallic foils. The metallic foil is one of many different possible metals depending on the desired color, luminescence, reflective properties, or texture. The metallic foil can be, for example, gold, silver, or bronze.

Choosing the color and gauge of the metallic foil is important to create a more pleasing three-dimensional appearance through enhanced lighting effects.

One can create accent colors using metallic foil or the foil can be applied to the entire artwork.

Now turning to a discussion of applying metallic paint.

Apply Metallic Paint

The tenth step in the process is to apply metallic paint. The metallic paint adds an iridescent, shimmery appearance that enhances the artwork. By way of example, in embodiments depicting fish, the metallic paint simulates light refracting through water and reflecting off of an object.

Just as with the selection of metallic foil, selecting the metallic paint depends on the lighting, color, and desired visual properties. The artist may choose from a wide variety of colors depending on the organism that will be depicted as well as the environment in which that organism will be set.

Now turning to a discussion of applying the glaze.

Apply Glaze

The eleventh step in the process is to apply the glaze. After the metallic paint dries, it is time to apply the glaze. One applies as many layers of colored or clear glazes as necessary to achieve the desired translucent effects.

The glaze enhances lighting characteristics. These lighting characteristics can be manipulated by applying a proper amount of glaze to depict environmental characteristics such as time of day and habitat.

Now turning to a discussion of applying mica powder.

Apply Mica Powder

The final step of the process is to apply mica powder. The mica powder creates a shimmery, pearlized, and iridescent effect. The mica powder is especially useful to create the appearance of light reflecting off of a fish in the water.

The result of the process is a luminescent, iridescent, and opalescent artwork.

The process disclosed within creates more realistic effects than acrylic paints, water colors, or oil paints. These other forms of art may use shading and coloring to simulate the lighting effects caused by the natural iridescence of a fish. But merely painting lighter colors does not create the actual effect of light passing through a glaze, reflecting off of a metal foil surface, and then traveling back through the glaze to the viewer's eye to recreate the iridescent, opalescent effect of watching light gleam off of a fish in nature.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a flowchart of the process.

FIG. 2 illustrates the throat pleats of a baleen whale that are produced in the scoring step of the process.

FIG. 3A illustrates the cutting step used to create the operculum of a fish.

FIG. 3B illustrates the elevating step used to create the operculum of a fish.

FIG. 4 illustrates a flow chart for making eyes according to the process.

FIG. 5A illustrates a textured plastic wrap suitable for use in the embossing step.

FIG. 5B illustrates a wire mesh suitable for use in the embossing step.

FIG. 5C illustrates a mesh produce bag suitable for use in the embossing step.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

The process uses a combination of aluminum, paints, metal foils, and powders to create realistic three-dimensional art. The paint, foils, and powders create three-dimensional lighting effects by simulating the way that light reflects and refracts off of the artwork.

Additionally, by using a sturdy base, a variety of tools can be used to create permanent three-dimensional effects. The structural three-dimensional effects include embossing, scoring, and elevating.

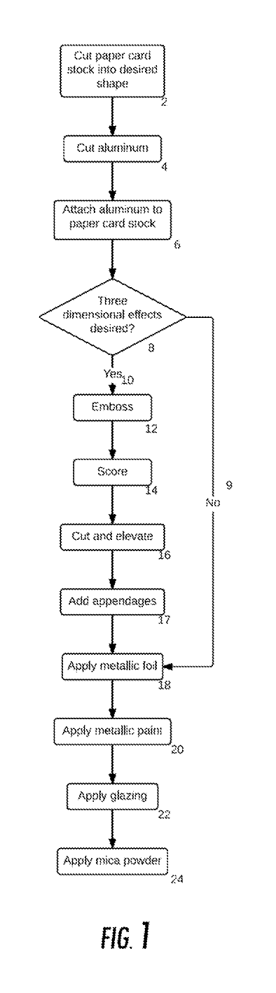

Referring to FIG. 1, a flowchart of the process is shown. The first step in the process is to cut the paper card stock into the desired shape 2. For example, the shape of a tuna. This step is optional depending on whether paper card stock is desired as the base layer. If a heavier gauge aluminum will be used, the artist may omit the paper card stock and simply use aluminum as the base layer.

The second step is to cut the aluminum 4 to match the card stock shape. If thinner aluminum is used, the aluminum is attached to the card stock. If thicker aluminum is used, the strength of thicker aluminum is sufficient as the base layer.

The third step in the process is to attach the aluminum to the card stock. This step is only required when using thinner aluminum. The card stock and aluminum may be attached by any suitable adhesive or attachment means.

The fourth step is to determine which, if any, three-dimensional effects are desired 8. If no three-dimensional effects are desired 9, an artist may skip to the ninth step to apply the metallic foil 18. The artwork will still benefit from the lighting effects created by combining the foil, paint, glaze, and powder.

If three-dimensional effects are desired 10, one proceeds to emboss 12, score 14, and cut and elevate 16 the desired three-dimensional features onto the artwork.

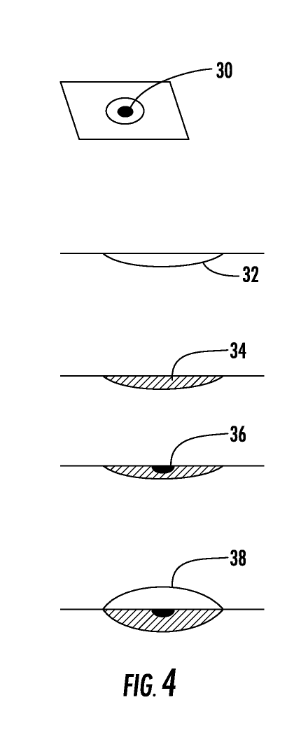

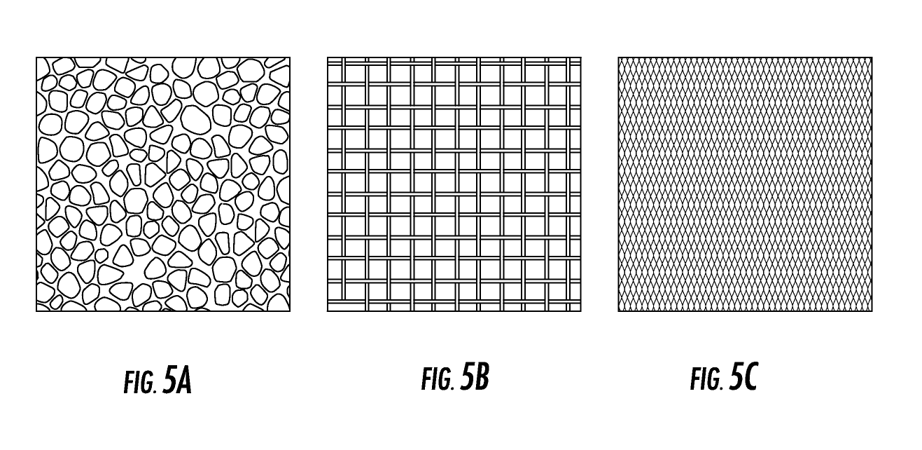

For the fifth step, the artist may emboss 12 the entire surface of the artwork to create a uniform texture. Or the artist may emboss 12 only on certain portions of the artwork to create accents. An example of embossing can be seen in FIG. 5.

For the sixth step, the artist will score 14 features directly onto the aluminum. Due to the physical properties of aluminum, scoring grooves into aluminum will result in prominent markings that add lifelike visual effects to the artwork.

For the seventh step, the artist will cut and elevate 16 portions of the artwork to create three-dimensional structures. For this step, a sharp utensil is used to carve through each layer until an incision has been made fully through the aluminum. If using a card stock base to support a thinner gauge of aluminum, one must also cut through the card stock layer.

The eighth step, which is optional depending on the organism being depicted, is to add appendages 17 to the artwork. To add an appendage 17, the appendage is formed from a separate piece of aluminum. Other optional aspects that can enhance the lifelike appearance of the appendages are to emboss or score the appendage to create textures. Once the appendage is complete, it is attached to the artwork.

The ninth step is to attach metallic foil 18.

The tenth step is to apply metallic paint 20. As many coats of metallic paint are applied as are necessary to achieve the desired richness of color.

The eleventh step is to apply the glaze 22. As many coats of glaze are applied as are necessary to achieve the optimum luminescence and opalescence. The glaze may be clear or color depending on the desired lighting effects.

The final step is to apply the mica powder 24.

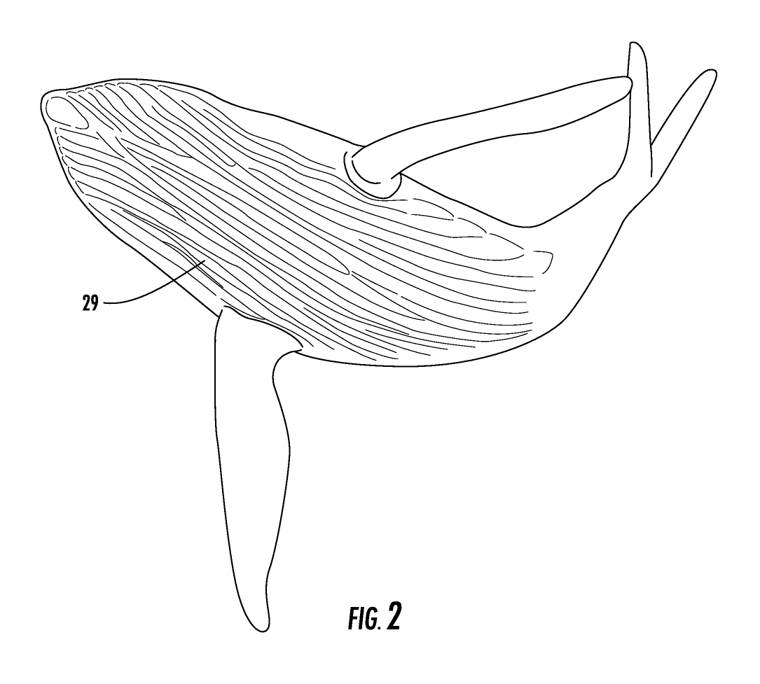

Referring to FIG. 2 an illustration of the throat pleats on a cetacean are shown. The throat pleats 29 are created by scoring grooves into the aluminum. The physical grooves enhance the lifelike effects of the artwork.

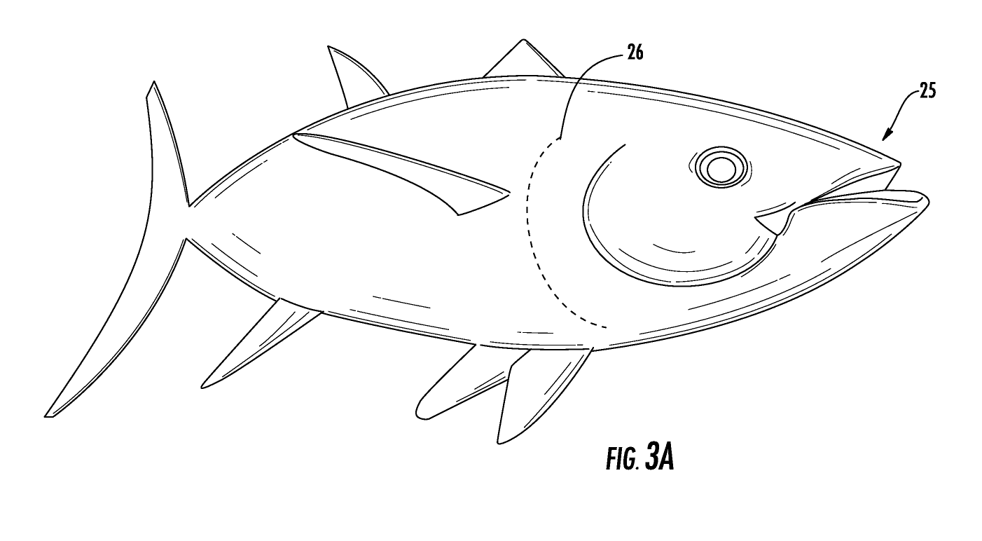

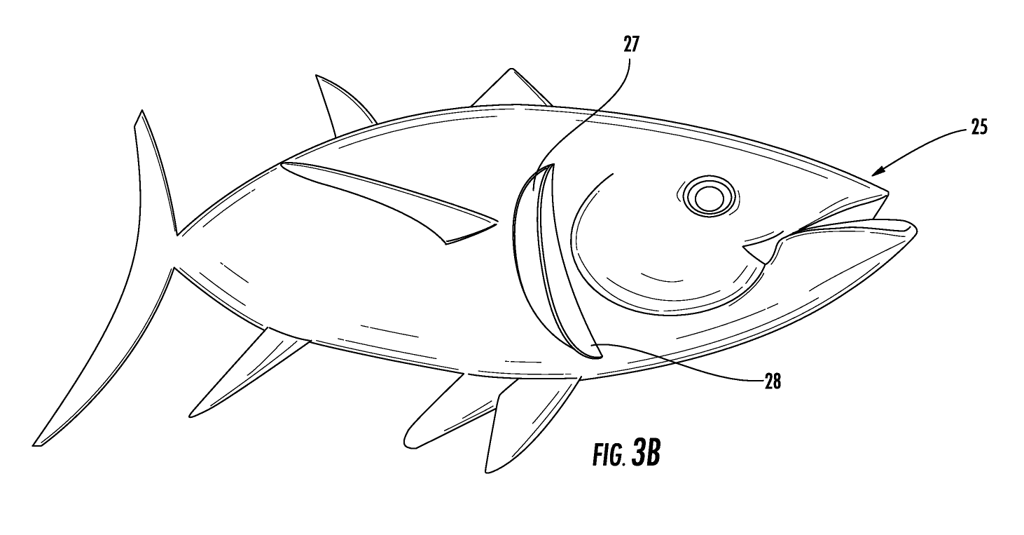

Referring to FIG. 3A, the first step of creating the raised operculum is shown. The raised operculum is created in the cut and elevate step of the process.

The operculum is the gill plate cover on a fish. In the process, the operculum is created by carving a semicircular arc 26 on a piece of aluminum art depicting a fish 25. The arc 26 is cut through every layer from the metallic foil through the aluminum and card stock. Carving the semicircular arc 26 is performed with any suitable cutting utensil.

Next, the operculum is pushed up and away 28 from the body of the fish 25, as shown in FIG. 3B.

In one embodiment, red paper or red paint is applied under the operculum 27 to resemble the oxygenated gills of a fish while breathing.

Referring to FIG. 4, a flowchart of the process for creating eyes is shown. An eye 30 is created by the following series of steps:

First, a circular indentation 32 is scored in the aluminum. The scoring tool may be a scalpel, knife, pin, pen, or other suitable scoring utensil. Next, the circular indentation 32 is painted to create the iris 34. Then, the pupil 36 is formed by placing a small amount of black paint inside the iris 34. Lastly, a glaze is poured over the iris 34 and pupil 36, creating a convex bubble of glaze 38 raised above the aluminum. This convex bubble 38 forms the cornea of the eye.

Referring now to FIG. 5, suitable embossing materials are shown that are used to create skin textures. FIG. 5A depicts textured plastic wrap. FIG. 5B depicts wire mesh. FIG. 5C depicts a mesh produce bag.

The three-dimensional aspects of the process will be better appreciated when demonstrated on actual pieces of art. The following figures are color photographs of various pieces of art created using the process.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an exemplary and explanatory embodiment thereof. It is the intention of the following claims to encompass and include such changes.

What is claimed is:

1. A process of creating a three-dimensional artwork comprising:
a. cutting a card stock into a shape;
b. cutting aluminum of a preferred thickness to match the shape of the card stock;
c. attaching the aluminum to the card stock;
d. attaching a metallic foil of different color to the aluminum;
e. applying a glaze; and
f. applying mica powder.

2. The process of creating a three-dimensional artwork of claim 1, wherein a portion of the aluminum is cut and elevated to create an operculum.

3. The process of creating a three-dimensional artwork of claim 1, wherein the metallic foil is selected from the group consisting of: gold foil, silver foil, and bronze foil.

4. The process of creating a three-dimensional artwork of claim 1, further comprising the additional step of attaching an embossing material to the aluminum after attaching the aluminum to the card stock but before attaching the metallic foil.

5. The process of creating a three-dimensional artwork of claim 5, wherein the embossing material is selected from the group consisting of: wire mesh, mesh produce bag, and textured plastic wrap.

6. The process of creating a three-dimensional artwork of claim 1, wherein step c includes scoring the aluminum to create grooves that represent throat pleats.

7. The process of creating a three-dimensional artwork of claim 1, further comprising, after step c, the steps:
a. scoring a circular indentation in the aluminum;
b. painting the circular indentation with metallic paint;
c. painting a center portion of the circular indentation with black paint; and
d. applying glaze over the circular indentation to form a convex bubble of glaze.

8. A three-dimensional artwork comprising:
a. a layer of card stock;
b. a layer of aluminum, the layer of aluminum affixed to the layer of card stock;
c. a layer of metallic foil, the layer of metallic foil affixed to the layer of aluminum;
d. a layer of metallic paint, the layer of metallic paint at least partially coating the layer of metallic foil;
e. a layer of glaze, the layer of glaze coating the layer of metallic paint;
f. a layer of mica powder, the layer of mica powder partially coating the layer of metallic paint and the layer of glaze; and
g. whereby the combination of the layer of metallic paint, the layer of glaze, and the layer of mica powder creates an artwork with iridescent, luminescent, and opalescent lighting effects.

9. The three-dimensional artwork of claim 8 wherein a portion of the layer of card stock and the layer of aluminum are cut and elevated to represent an operculum of a fish.

10. The three-dimensional artwork of claim 8 further comprising a layer of textured material, the layer of textured material between the layer of aluminum and the layer of metallic foil.

11. The three-dimensional artwork of claim 10 wherein the layer of textured material is selected from the group of: textured plastic wrap, wire mesh, nylon mesh.

12. The three-dimensional artwork of claim 8 wherein the layer of aluminum is scored to create grooves, the grooves representing throat pleats.

13. The three-dimensional artwork of claim 8 further comprising:
a. an aluminum attachment representing a fin, the aluminum attachment affixed to the layer of aluminum; and
b. a plurality of wire segments representing spines, the plurality of wire segments affixed to the aluminum attachment.

14. The three-dimensional artwork of claim 8 further comprising a structure representing an eye, the structure representing an eye comprising:
a. a depression in the aluminum layer;
b. a first layer of paint partially covering the depression;
c. a second layer of paint in the center of the first layer of paint; and
d. a layer of clear glaze forming a convex bubble fully covering the depression, the first layer of paint, and the second layer of paint.

15. A process of creating a three-dimensional artwork by combining aluminum, metallic foil, metallic paints, colored glazes, and mica powders comprising:
a. cutting card stock into a shape;
b. cutting aluminum to match the shape of the card stock;
c. attaching the aluminum to the card stock;
d. placing an embossing material on top of the aluminum;
e. attaching a metallic foil on top of the embossing material;
f. pressing the metallic foil to reveal the texture of the embossing material;
g. scoring, painting, and glazing a section of the aluminum to create a structure representing an eye;
h. applying a metallic paint;
i. applying a glaze;
j. applying mica powder to yield a pearlized, iridescent effect to the three-dimensional artwork; and
k. curing the artwork.

16. The process to create a three-dimensional artwork of claim 16, wherein the aluminum is between 0.006 millimeters and 0.2 millimeters thick.

17. The process to create a three-dimensional artwork of claim 16, wherein scoring, painting, and glazing a section of the aluminum to create a structure representing an eye comprises the steps of:
a. scoring out a circular depression in the aluminum;
b. painting the circular depression a color to create an iris;
c. painting a small black circle inside the iris to create a pupil; and
d. covering the circular depression, the iris, and the pupil with a glaze wherein the glaze forms a convex bubble.

18. The process to create a three-dimensional artwork of claim 16 wherein the shape is a fish, and between steps f and g further comprising the steps of:
a. cutting a semicircle through the card stock, the aluminum, the embossing material, and the metallic foil;
b. elevating the semicircle to create a three-dimensional structural characteristic representing an operculum; and
c. applying plaster to the back portion of the semicircle to create a three-dimensional structural characteristic representing an operculum.

19. The process to create a three-dimensional artwork of claim 16 further comprising, between steps c and d, the step of scoring grooves into the cetacean to represent throat pleats, wherein the shape is a cetacean.
